(19) United States
(12) Patent Application Publication
(10) Pub. No.: US 2019/0286388 A1
(43) Pub. Date: Sep. 19, 2019

(54) INFORMATION PROCESSING SYSTEM AND APPARATUS

(71) Applicant: FUJI XEROX CO., LTD., Tokyo (JP)

(72) Inventor: Yang LIU, Kanagawa (JP)

(73) Assignee: FUJI XEROX CO., LTD., Tokyo (JP)

(21) Appl. No.: 16/292,353

(22) Filed: Mar. 5, 2019

(30) Foreign Application Priority Data
Mar. 15, 2018 (JP) 2018-048625

(51) Int. Cl. G06F 3/12

(52) U.S. Cl. CPC G06F 3/1222; G06F 3/1292; G06F 3/1238

(57) ABSTRACT

An information processing system includes first, second, and third obtaining units and an executor. The first obtaining unit obtains first information. The first information is information used for uniquely identifying a user sending a request to execute processing or an apparatus used for sending the request. The first information is issued together with the request and is associated with the request. When an instruction to execute the processing is provided, the second obtaining unit obtains second information to be checked against the first information. The second information is obtained, separately from the first information obtained by the first obtaining unit, from a user providing the instruction or from an apparatus carried by the user. The third obtaining unit obtains the request. The executor executes processing based on the request obtained by the third obtaining unit in accordance with a result of checking the second information against the first information.

### CROSS-REFERENCE TO RELATED APPLICATIONS

This application is based on and claims priority under 35 USC 119 from Japanese Patent Application No. 2018-048625 filed Mar. 15, 2018.

### Background

### (i) Technical Field

The present disclosure relates to an information processing system and apparatus.

### (ii) Related Art

Various authentication technologies have been proposed so far. Japanese Unexamined Patent Application Publication No. 2017-16242 discloses an authentication device for conducting user authentication by using a wearable terminal worn by a user. This authentication device includes a storage, a communication unit, and an authentication unit. The storage stores authentication information indicating registered terminal information for identifying a wearable terminal worn by a user. The communication unit performs communication with the wearable terminal to obtain the terminal information. The authentication unit conducts user authentication when the communication unit has obtained the terminal information. Japanese Unexamined Patent Application Publication No. 2017-107387 discloses an authentication device that communicates with a wearable terminal which conducts biometric authentication of a user wearing this wearable terminal. When the wearable terminal approaches the authentication device, the authentication device receives information from the wearable terminal and authenticates the user wearing the wearable terminal based on the received information. After this authentication, another authentication is conducted for a user operating an operation panel based on the features of a hand or an arm of this user.

### SUMMARY

In the above-described authentication method, authentication information is registered in advance and is then checked against authentication information input when authentication is conducted. This method requires a procedure of registering authentication information in advance, which is time-consuming and requires some efforts of a user.

Aspects of non-limiting embodiments of the present disclosure relate to an information processing system and apparatus which make it possible to reduce time and effort of a user when executing authentication processing, compared with the configuration in which authentication information is registered in advance.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including first, second, and third obtaining units and an executor. The first obtaining unit obtains first information. The first information is information used for uniquely identifying a user sending a request to execute processing or an apparatus used for sending the request. The first information is issued together with the request and is associated with the request. When an instruction to execute the processing is provided, the second obtaining unit obtains second information to be checked against the first information. The second information is obtained, separately from the first information obtained by the first obtaining unit, from a user providing the instruction or from an apparatus carried by the user. The third obtaining unit obtains the request. The executor executes processing based on the request obtained by the third obtaining unit in accordance with a result of checking the second information against the first information.

### BRIEF DESCRIPTION OF THE DRAWINGS

Exemplary embodiments of the present disclosure will be described in detail based on the following figures, wherein:

FIG. 1 is a schematic diagram illustrating the overall configuration of an information processing system according to a first exemplary embodiment;

FIG. 2 is a block diagram illustrating an example of the functional configuration of a terminal apparatus according to the first exemplary embodiment;

FIG. 3 is a block diagram illustrating an example of the functional configuration of an image processing apparatus according to the first exemplary embodiment;

FIG. 4 is a flowchart illustrating an operation executed by the terminal apparatus of the first exemplary embodiment to issue checking information together with a processing request and to send them to the image processing apparatus of the first exemplary embodiment;

FIG. 5 is a flowchart illustrating a checking operation executed by the image processing apparatus of the first exemplary embodiment;

FIG. 6 illustrates an example of a display screen of a display on which a list of processing requests is displayed;

FIG. 7 is a block diagram illustrating an example of the functional configuration of a terminal apparatus according to a second exemplary embodiment;

FIG. 8 is a schematic diagram illustrating the overall configuration of an information processing system according to a third exemplary embodiment;

FIG. 9 is a block diagram illustrating an example of the functional configuration of a server according to the third exemplary embodiment;

FIG. 10 is a flowchart illustrating a checking operation executed by an image processing apparatus of the third exemplary embodiment;

FIG. 11 is a block diagram illustrating an example of the functional configuration of a terminal apparatus according to a fourth exemplary embodiment; and

FIG. 12 is a block diagram illustrating an example of the functional configuration of a server of the fourth exemplary embodiment.

### DETAILED DESCRIPTION

The exemplary embodiments of the disclosure will be described below in detail with reference to the accompanying drawings. In the exemplary embodiments, a terminal apparatus sends a request to execute processing to an information processing apparatus. In the following exemplary embodiments, the disclosure is applied to an information processing system including an image processing apparatus, which is an example of the information processing apparatus.

### First Exemplary Embodiment

### (System Configuration)

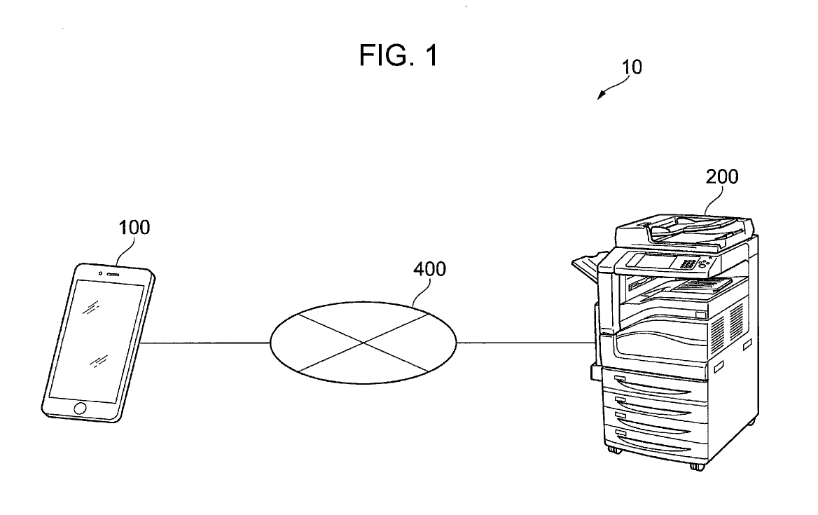

FIG. 1 is a schematic diagram illustrating the overall configuration of an information processing system 10 according to a first exemplary embodiment. The information processing system 10 includes a terminal apparatus 100 and an image processing apparatus 200 connected to each other via a network 400.

The terminal apparatus 100 is used by an operator to send a request to instruct the image processing apparatus 200 to execute processing. The terminal apparatus 100 has a communication function of sending a processing request to the image processing apparatus 200 via the network 400. The terminal apparatus 100 also has a function of sending checking information to the image processing apparatus 200 together with the processing request. The checking information is used by the image processing apparatus 200 to perform checking operation when executing processing. The terminal apparatus 100 may also have a function of sending data to the image processing apparatus 200 together with the processing request. This data is used by the image processing apparatus 200 to execute processing based on the processing request. As the terminal apparatus 100, a mobile information terminal, such as a laptop personal computer (PC), a tablet information terminal, or a smartphone, is used.

The image processing apparatus 200 receives a processing request from the terminal apparatus 100 and executes image processing based on the request. The image processing apparatus 200 has a communication function of receiving a processing request from the terminal apparatus 100 via the network 400. The image processing apparatus 200 forms an image on a recording material, such as a sheet, and has functions of copying, scanning, fax sending and receiving, and printing. It is not necessary, however, that the image processing apparatus 200 have all of these functions. The image processing apparatus 200 may be an apparatus dedicated to the use of one of the functions, that is, it may be a copying machine, a scanner, a fax sender-and-receiver, or a printer.

The network 400 may be any type of communication network used for data communication between the terminal apparatus 100 and the image processing apparatus 200. The network 400 may be a local area network (LAN), a wide area network (WAN), or the Internet. A communication line used for data communication may be a wired medium or a wireless medium, or a combination thereof. For example, the terminal apparatus 100 may be wirelessly connected to the network 400, while the image processing apparatus 200 may be connected to the network 400 via a wired medium. The terminal apparatus 100 and the image processing apparatus 200 may be connected via plural networks or communication lines by using a relay device, such as a gateway or a router.

### (Functional Configuration of Terminal Apparatus)

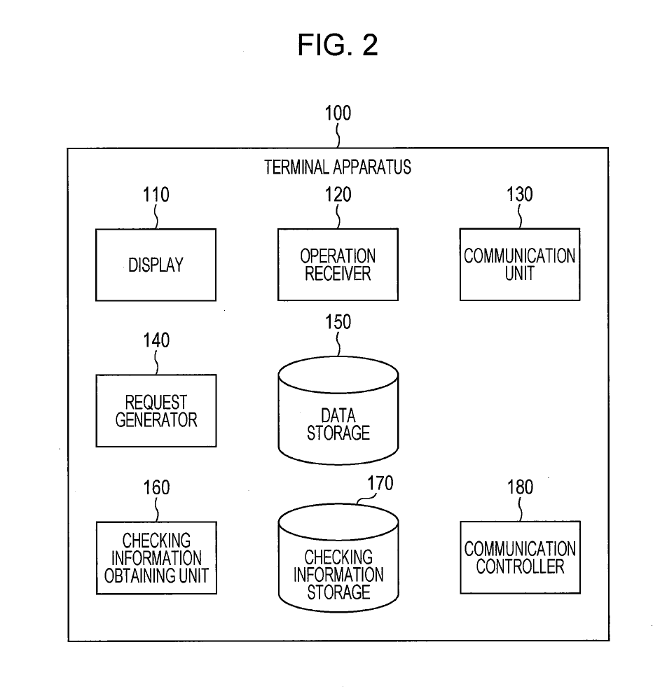

FIG. 2 is a block diagram illustrating an example of the functional configuration of the terminal apparatus 100 according to the first exemplary embodiment. The terminal apparatus 100 includes a display 110, an operation receiver 120, a communication unit 130, a request generator 140, a data storage 150, a checking information obtaining unit 160, a checking information storage 170, and a communication controller 180.

The display 110 displays various screens, such as information providing screens and operation screens. If the terminal apparatus 100 is a smartphone or a tablet information terminal, the display 110 is implemented by the display device of the smartphone or the tablet information terminal.

The operation receiver 120 receives an operation input by an operator of the terminal apparatus 100. If the terminal apparatus 100 is a smartphone or a tablet information terminal, the operation receiver 120 is implemented by a touchscreen overlaid on the display device of the smartphone or the tablet information terminal. An operation screen for receiving an operation from the operator is displayed on the display 110, and the operation receiver 120 receives an operation input from the operator using the operation screen, thereby implementing a user interface (UI) of the terminal apparatus 100.

The communication unit 130 performs communication to exchange data with an external device via the network 400. The interface of the communication unit 130 is determined by the method by which the terminal apparatus 100 connects to the network 400. If the terminal apparatus 100 is a smartphone, the communication unit 130 is implemented by a wireless communication interface, such as a mobile-communication telephone circuit, Wi-Fi, or Bluetooth (registered trademark). The communication unit 130 may be implemented by a combination of a wireless communication interface and a wired communication interface, such as a universal serial bus (USB).

The request generator 140 generates a processing request to instruct the image processing apparatus 200 to execute processing. In the first exemplary embodiment, the request generator 140 generates a request to output an image or a document, for example. More specifically, the request generator 140 generates a processing request by selecting a file to be output and by setting certain settings, such as the number and the size of pages to be output. A processing request is generated based on the operation received by the operation receiver 120 and is sent to the image processing apparatus 200 by the communication unit 130 via the network 400.

The data storage 150 stores data used by the image processing apparatus 200 to execute processing. The data storage 150 is implemented by a random access memory (RAM), for example. Data stored in the data storage 150 is image files and document files to be output, for example. Data stored in the data storage 150 may be images captured by a camera provided in the terminal apparatus 100 or text files input by operating an input device, such as a keyboard, provided in the terminal apparatus 100. Instead of being stored in the data storage 150, data to be processed may be obtained from a server in the network 400. In this case, the data storage 150 is an optional element.

The checking information obtaining unit 160 obtains information to be used for a checking operation performed by the image processing apparatus 200 when executing processing. Checking information obtained by the checking information obtaining unit 160 is an example of first information. In the first exemplary embodiment, feature information concerning the features of the operator of the terminal apparatus 100 is used as checking information. More specifically, biometric information concerning the operator may be used. As the biometric information, information used in known authentication technologies, such as a three-dimensional face image, a two-dimensional face image, fingerprint, voiceprint, and vein patterns, may be used.

The configuration of the checking information obtaining unit 160 varies according to the type of information used as checking information. If a face image of the operator is used as checking information and if the terminal apparatus 100 is a smartphone or a tablet information terminal, a camera provided in the terminal apparatus 100 may be used as the checking information obtaining unit 160. If a fingerprint of the operator is used as checking information, an authentication fingerprint sensor provided in the terminal apparatus 100 may be used as the checking information obtaining unit 160.

The checking information storage 170 stores information to be used for a checking operation performed by the image processing apparatus 200 when executing processing. The checking information storage 170 stores information obtained by the checking information obtaining unit 160. The checking information storage 170 is implemented by a RAM, for example. If information which is not required to be obtained by the checking information obtaining unit 160, such as identification information concerning the terminal apparatus 100, is used as checking information, it is stored in the checking information storage 170 in advance.

The communication controller 180 is a controller that controls communication performed by the communication unit 130 with an external device. The communication controller 180 issues a processing request to instruct the image processing apparatus 200 to execute processing and checking information associated with this processing request, and instructs the communication unit 130 to send the issued processing request and checking information. The communication controller 180 issues a processing request by selecting processing to be executed by the image processing apparatus 200 and by instructing the request generator 140 to generate a processing request. The communication controller 180 issues checking information by selecting checking information stored in the checking information storage 170 and by associating the selected checking information with a processing request. Alternatively, the communication controller 180 may instruct the checking information obtaining unit 160 to obtain checking information when issuing checking information.

### (Functional Configuration of Image Processing Apparatus)

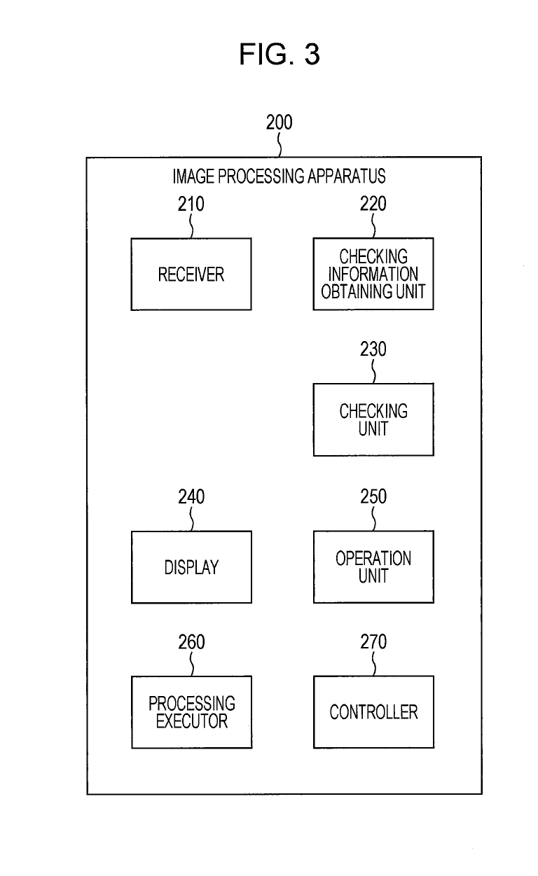

FIG. 3 is a block diagram illustrating an example of the functional configuration of the image processing apparatus 200 according to the first exemplary embodiment. The image processing apparatus 200 includes a receiver 210, a checking information obtaining unit 220, a checking unit 230, a display 240, an operation unit 250, a processing executor 260, and a controller 270.

The receiver 210 receives data sent from an external device via the network 400. The receiver 210 is implemented by a network interface for connecting to the network 400. The receiver 210 receives a processing request and checking information, which serves as the first information, sent from the terminal apparatus 100. The receiver 210 is an example of a first obtaining unit and an example of a third obtaining unit. The receiver 210 also receives data to be processed by the processing executor 260 based on a processing request. The receiver 210 is an example of a fourth obtaining unit. The receiver 210 may receive data directly from the terminal apparatus 100 or from a server in the network 400 in response to an instruction from the terminal apparatus 100.

The checking information obtaining unit 220 obtains information to be used for a checking operation performed by the image processing apparatus 200 when executing processing. Checking information obtained by the checking information obtaining unit 220 is an example of second information. The checking information obtaining unit 220 is an example of a second obtaining unit. As discussed in the explanation of the checking information obtaining unit 160 of the terminal apparatus 100, feature information concerning the operator of the terminal apparatus 100 is used as checking information in the first exemplary embodiment. Checking information obtained by the checking information obtaining unit 220 is information provided by the operator of the image processing apparatus 200. Accordingly, both of checking information issued by the terminal apparatus 100 and checking information obtained by the checking information obtaining unit 220 are information obtained from the subject (operator) possessing checking information to be presented to the checking information obtaining unit 220.

The configuration of the checking information obtaining unit 220 varies according to the type of information used as checking information. If a face image of the operator is used as checking information, a camera for capturing an image of the face of the operator is used as the checking information obtaining unit 220. If a fingerprint of the operator is used as checking information, an authentication fingerprint sensor is used as the checking information obtaining unit 220.

The checking unit 230 is a processor for performing a checking operation by using checking information. The checking unit 230 checks checking information obtained by the checking information obtaining unit 220 against checking information obtained by the receiver 210 via the network 400. When the two items of checking information match each other, it is possible to execute processing based on the processing request associated with the checking information. In the first exemplary embodiment, the image processing apparatus 200 performs checking operation by using the checking unit 230. However, the image processing apparatus 200 may send checking information received by the receiver 210 and that obtained by the checking information obtaining unit 220 to an external checking server, instruct it to perform checking operation, and then obtain the checking results from the external checking server.

The display 240 presents various items of information to the operator of the image processing apparatus 200. The display 240 is implemented by a liquid crystal display, for example. Operation screens concerning operations that can be received from the operator are displayed on the display 240. Various other screens, such as menu screens, selection screens for selecting processing to be executed, and setting screens are displayed on the display 240 in accordance with the operation from the operator.

The operation unit 250 receives an operation from the operator. The operation unit 250 is implemented by a touchscreen or a key switch, for example. If the operation unit 250 is a touchscreen, it may be overlaid on the display 240 to receive an operation performed by the operator using the touchscreen in accordance with an operation screen displayed on the display 240. In this manner, the UI of the image processing apparatus 200 is implemented. The operation unit 250 is an example of an instruction receiver.

The processing executor 260 executes processing based on a processing request sent from the terminal apparatus 100. The processing executor 260 is an example of an executor. In the image processing apparatus 200, the processing executor 260 is implemented by an image forming mechanism, an image reading mechanism, and a data processor, for example. The image forming mechanism is constituted by a printer, which forms an image or a document decompressed from an image file or a document file on a medium, such as a sheet, by using an image forming material, such as toner, in accordance with a processing request, and outputs the medium on which the image or document is formed. The image reading mechanism is a scanner, which optically reads an image of a document set in the scanner to generate the read image (image data). The data processor is implemented as a result of a central processing unit (CPU) executing a program, and executes data processing, such as image conversion.

The controller 270 controls operations and processing operations performed by the above-described functions of the image processing apparatus 200. More specifically, the controller 270 performs control so that the checking information obtaining unit 220 obtains checking information, the receiver 210 obtains checking information, a processing request, and data to be processed, and the checking unit 230 performs checking operation. The controller 270 also performs control that the display 240 displays screens, the operation unit 250 receives operations, and the processing executor 260 executes processing.

### (Checking Operation Using Checking Information)

Checking operation using checking information will now be discussed below. In the first exemplary embodiment, checking operation is performed by comparing checking information issued together with a processing request by the terminal apparatus 100 with that obtained by the checking information obtaining unit 220 of the image processing apparatus 200.

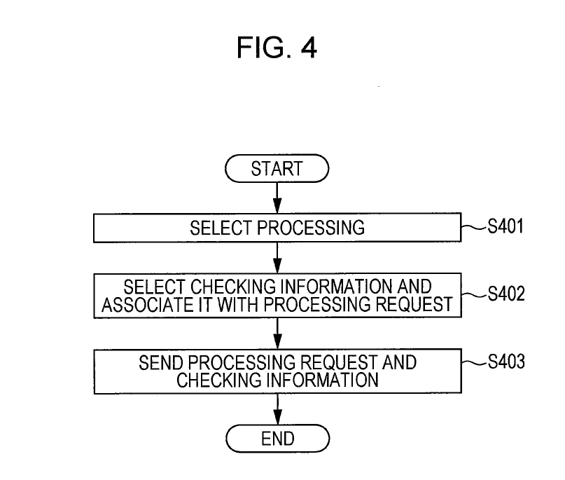

FIG. 4 is a flowchart illustrating an operation executed by the terminal apparatus 100 to issue checking information together with a processing request and to send them to the image processing apparatus 200. In step S401, the operator of the terminal apparatus 100 operates the operation receiver 120 to select processing to be executed by the image processing apparatus 200. In step S402, the operator then operates the operation receiver 120 to select checking information to be used for performing a checking operation among items of checking information stored in the checking information storage 170 and associates the selected checking information with a processing request. Then, in step S403, the operator sends (issues) the processing request and the checking information to the image processing apparatus 200 in association with each other.

Although in FIG. 4 the operator first selects processing to be executed in step S401, it may select checking information first. Instead of selecting checking information stored in the checking information storage 170 and issuing it, the operator may instruct the checking information obtaining unit 160 to obtain checking information when issuing checking information. More specifically, upon issuing checking information, the checking information obtaining unit 160 may obtain biometric information concerning the operator, such as a face image or a fingerprint, as checking information.

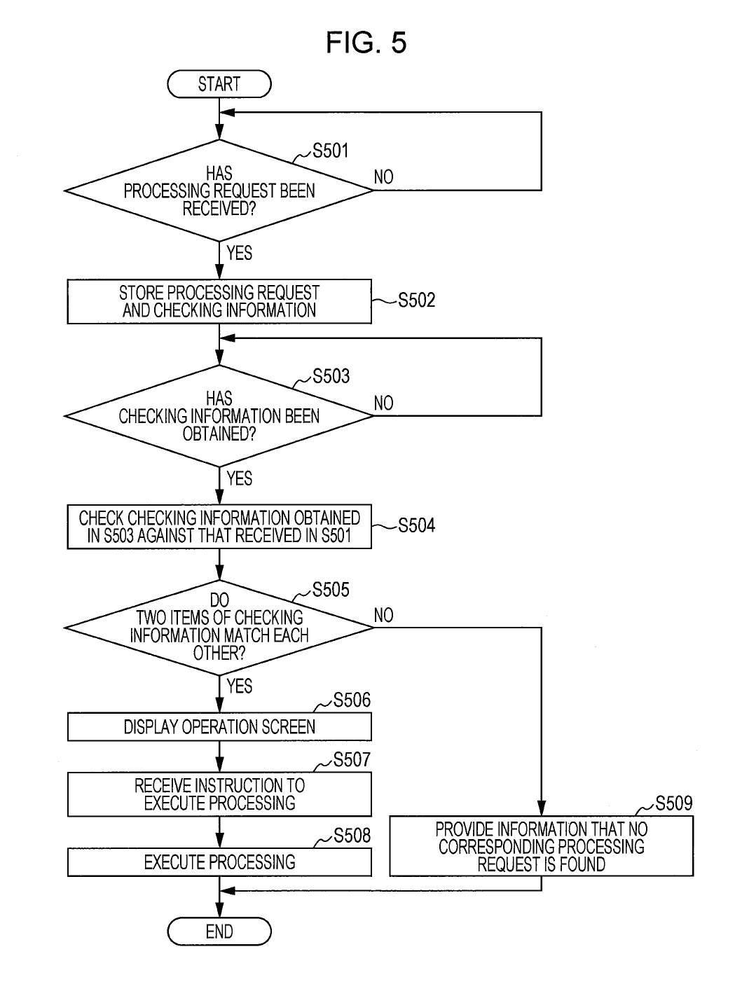

FIG. 5 is a flowchart illustrating checking operation executed by the image processing apparatus 200. When the receiver 210 receives a processing request addressed to this image processing apparatus 200 from the terminal apparatus 100 in step S501, the image processing apparatus 200 stores the received processing request and checking information in a storage device (not shown) in step S502. The storage device is implemented by a RAM or a magnetic disk drive.

Then, upon obtaining checking information by the checking information obtaining unit 220 in step S503, in step S504, the checking unit 230 checks the checking information obtained in step S503 against the checking information received together with the processing request in step S501. In step S503, in a situation where checking information can be obtained, the checking information obtaining unit 220 automatically performs an operation for obtaining checking information. In the first exemplary embodiment, feature information concerning the operator of the terminal apparatus 100 is used as checking information. Checking information is obtained by various obtaining devices, such as a camera, a fingerprint sensor, and a sound sensor, according to the type of information. When a human sensor (not shown), for example, provided in the image processing apparatus 200 has detected a person approaching the image processing apparatus 200, the above-described various obtaining devices start functioning and become ready to receive feature information. The checking information obtaining unit 220 obtains all items of information that may be used as checking information. The checking unit 230 then checks the items of information obtained by the checking information obtaining unit 220 against the checking information received together with the processing request.

If it is found from the checking results obtained by the checking unit 230 that the checking information obtained in step S503 matches that received in step S501 (YES in step S505), in step S506, the controller 270 causes the display 240 to display an operation screen for executing processing based on the processing request received in step S501. The operator then operates the operation unit 250 based on the operation screen to provide an instruction to execute processing. The controller 270 receives the instruction in step S507 and causes the processing executor 260 to execute processing based on the processing request in step S508. The operator may cancel the processing request on the operation screen instead of executing it. If it is found that the checking information obtained in step S503 does not match that received in step S501 (NO in step S505), in step S509, the controller 270 provides information that no processing request associated with the checking information is found and terminates processing.

It is now assumed that, when the operator operates the image processing apparatus 200, multiple processing requests using the same checking information have already been received from the terminal apparatus 100. In this case, after the checking operation has successfully performed by the checking unit 230 (YES in step S505), the controller 270 causes the display 240 to display a list of the multiple processing requests received from the terminal apparatus 100. The controller 270 and the display 240 are an example of a presenter. The operator then operates the operation unit 250 to select a processing request to be executed among the displayed processing requests. Then, the controller 270 causes the display 240 to display an operation screen for executing processing based on the selected processing request and then returns to step S506.

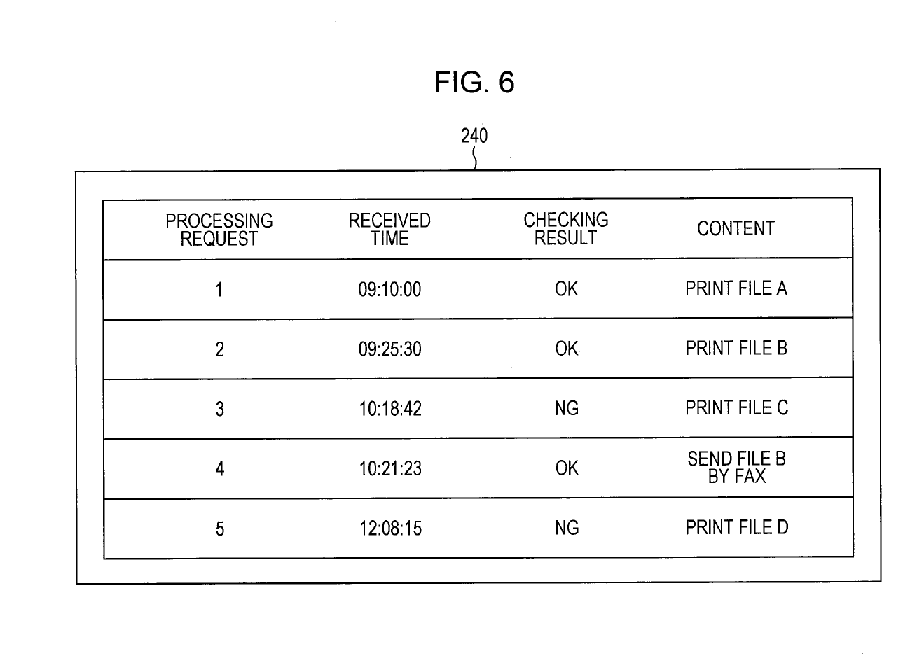

FIG. 6 illustrates an example of a display screen of the display 240 on which a list of processing requests is displayed. In the example in FIG. 6, three processing requests (processing requests 1, 2, 4) are requests for which the checking unit 230 has checked that checking information obtained by the image processing apparatus 200 and that from the terminal apparatus 100 match each other. Two processing requests (processing requests 3, 5) are requests for which the checking unit 230 has found that checking information obtained by the image processing apparatus 200 and that from the terminal apparatus 100 do not match each other. These two processing requests may have been made by a person different from the operator of the image processing apparatus 200. The operator operates the operation unit 250 to select a processing request among the displayed processing requests, and causes the processing executor 260 to execute processing. When the processing has been executed, the controller 270 deletes the corresponding processing request from the list. Thereafter, the operator sequentially selects the remaining processing requests.

As described above, in the first exemplary embodiment, the terminal apparatus 100 issues a processing request associated with checking information and sends it to the image processing apparatus 200. The image processing apparatus 200 receives the processing request with checking information from the terminal apparatus 100 and separately obtains checking information from the operator of the image processing apparatus 200. In the first exemplary embodiment, therefore, the operator of the terminal apparatus 100 is only required to produce checking information when issuing a processing request and does not have to register authentication information in advance.

### Second Exemplary Embodiment

### (System Configuration)

The system configuration of a second exemplary embodiment is similar to that of the first exemplary embodiment shown in FIG. 1. In the second exemplary embodiment, instead of feature information concerning the operator of the terminal apparatus 100, identification information for identifying the terminal apparatus 100, which is an apparatus that issues a request, is used as checking information. More specifically, a media access control (MAC) address or a serial number, which serves as product information concerning the terminal apparatus 100, may be used.

### (Functional Configuration of Terminal Apparatus)

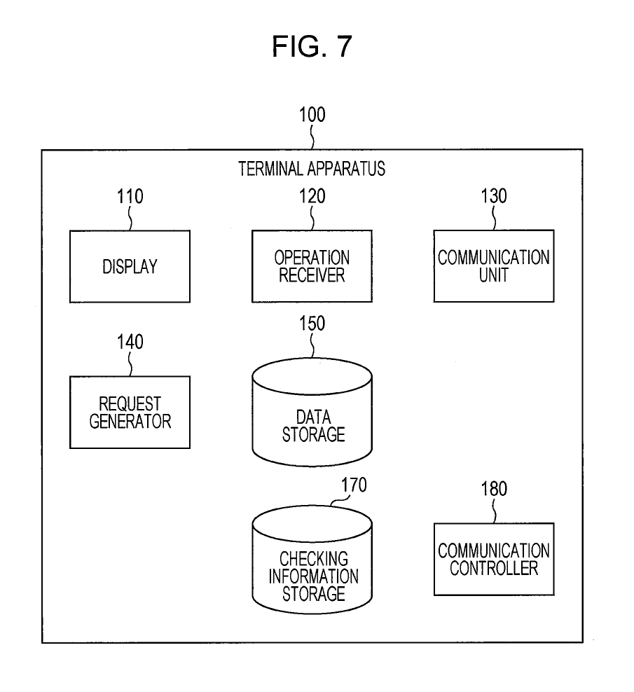

FIG. 7 is a block diagram illustrating an example of the functional configuration of a terminal apparatus 100 according to the second exemplary embodiment. The functional configuration of the terminal apparatus 100 according to the second exemplary embodiment is similar to that of the first exemplary embodiment. The terminal apparatus 100 shown in FIG. 7 includes a display 110, an operation receiver 120, a communication unit 130, a request generator 140, a data storage 150, a checking information storage 170, and a communication controller 180. Unlike the terminal apparatus 100 in FIG. 2, the terminal apparatus 100 in FIG. 7 does not have a checking information obtaining unit 160. In the second exemplary embodiment, identification information concerning the terminal apparatus 100 is used as checking information and is stored in the checking information storage 170 in advance. It is not necessary to obtain checking information by using the checking information obtaining unit 160, unlike the first exemplary embodiment.

### (Functional Configuration of Image Processing Apparatus)

The functional configuration of the image processing apparatus 200 according to the second exemplary embodiment is similar to that of the first exemplary embodiment. In the second exemplary embodiment, however, the checking information obtaining unit 220 obtains identification information concerning the terminal apparatus 100 as checking information. The configuration of the checking information obtaining unit 220 varies according to the transmission method for checking information. More specifically, a communication interface which is directly connected to the terminal apparatus 100 to obtain identification information is provided as the checking information obtaining unit 220. For example, a wireless communication interface, such as near field communication (NFC) or Bluetooth, or a wired interface, such as a USB or another cable, is provided as the checking information obtaining unit 220.

### (Checking Operation Using Checking Information)

In the second exemplary embodiment, checking operation using checking information is performed in a procedure similar to that of the first exemplary embodiment as discussed with reference to FIGS. 4 and 5. However, in the second exemplary embodiment, identification information concerning the terminal apparatus 100 is used as checking information, and thus, the process is slightly different from that of the first exemplary embodiment. As discussed above, checking information is stored in the terminal apparatus 100 in advance, and the operation for obtaining checking information is not performed when issuing a processing request and checking information.

In step S503 in FIG. 5, when being connected to the terminal apparatus 100, the information processing apparatus 200 obtains identification information, which serves as checking information, from the terminal apparatus 100. More specifically, when the image processing apparatus 200 is connected to the terminal apparatus 100 via wireless communication, such as NFC or Bluetooth, or via a cable, such as a USB, it obtains identification information via a certain interface serving as the checking information obtaining unit 220.

In the second exemplary embodiment, checking information obtained by the checking information obtaining unit 220 of the image processing apparatus 200 is information obtained from the terminal apparatus 100 carried by the operator of the image processing apparatus 200, that is, information provided by the operator of the image processing apparatus 200. Accordingly, both of checking information issued by the terminal apparatus 100 and checking information obtained by the checking information obtaining unit 220 are information obtained from the subject (terminal apparatus 100) possessing checking information to be presented to the checking information obtaining unit 220.

In the first exemplary embodiment, feature information concerning the operator of the terminal apparatus 100 is used as checking information. Thus, the operator of the terminal apparatus 100 and that of the image processing apparatus 200 are the same. In contrast, in the second exemplary embodiment, identification information concerning the terminal apparatus 100 is used as checking information. It is thus possible that the terminal apparatus 100 be handed to another person. This person may perform a checking operation by using the identification information concerning the terminal apparatus 100 and cause the image processing apparatus 200 to execute processing.

In the second exemplary embodiment, as stated above, identification information concerning the terminal apparatus 100 is used as checking information, instead of feature information concerning the operator of the terminal apparatus 100. However, feature information concerning the operator of the terminal apparatus 100 and identification information concerning the terminal apparatus 100 may selectively be used or both items of information may be used. When priority is given to enhancing the security, feature information concerning the operator of the terminal apparatus 100 may be used or a combination of the feature information and identification information concerning the terminal apparatus 100 may be used. When priority is given to allowing another person to operate the image processing apparatus 200, identification information concerning the terminal apparatus 100 may be used.

### Third Exemplary Embodiment

### (System Configuration)

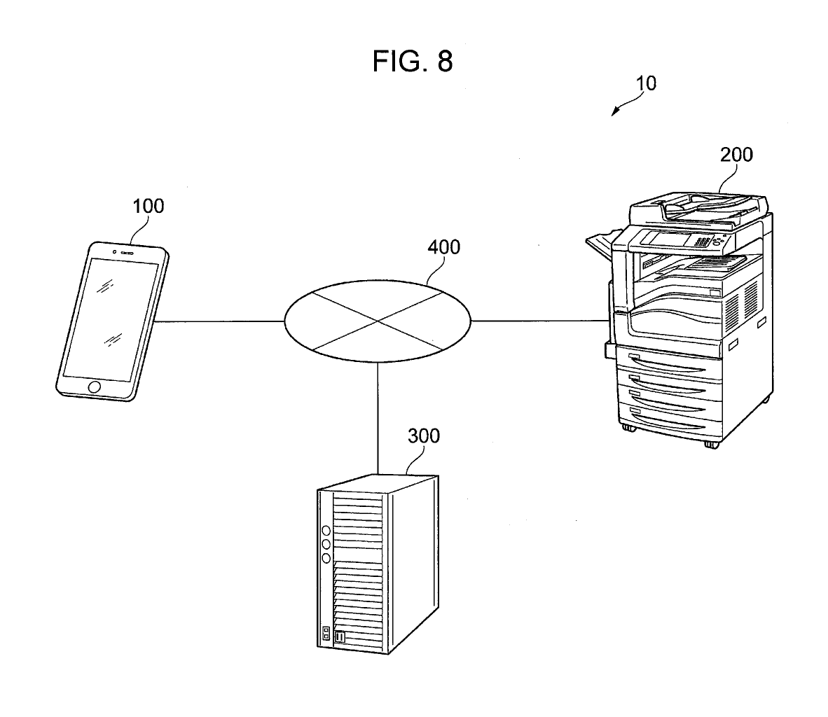

FIG. 8 is a schematic diagram illustrating the overall configuration of an information processing system 10 according to a third exemplary embodiment. The information processing system 10 includes a terminal apparatus 100, an image processing apparatus 200, and a server 300 that are connected to each other via a network 400. In the third exemplary embodiment, a processing request and checking information issued by the terminal apparatus 100 are not directly sent to the image processing apparatus 200, but are sent to the image processing apparatus 200 via the server 300.

### (Functional Configuration of Server)

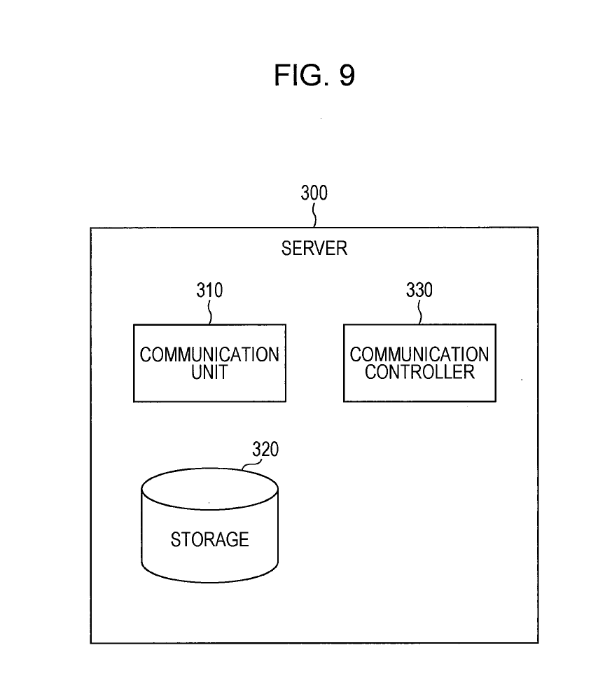

FIG. 9 is a block diagram illustrating an example of the functional configuration of the server 300 according to the third exemplary embodiment. The server 300 includes a communication unit 310, a storage 320, and a communication controller 330. The server 300 stores a processing request and checking information received from the terminal apparatus 100 and then sends them to the image processing apparatus 200. The server 300 is not restricted to a single server machine. The functions of the server 300 may be distributed over multiple server machines in a network and be performed, that is, the functions of the server 300 may be implemented in cloud environments.

The communication unit 310 performs communication to exchange data with an external device via the network 400. The communication unit 310 is implemented by a network interface for connecting to the network 400. The communication unit 310 connects to the terminal apparatus 100 to receive processing requests, checking information, and various items of information from the terminal apparatus 100. The communication unit 310 also connects to the image processing apparatus 200 to send processing requests, checking information, and various items of information to the image processing apparatus 200.

The storage 320 stores processing requests and checking information received from the terminal apparatus 100. The storage 320 is implemented by a storage device, such as a magnetic disk drive or a solid state drive (SSD). If data to be processed is sent together with a processing request and checking information from the terminal apparatus 100, it is also stored in the storage 320.

The communication controller 330 is a controller that controls communication performed with an external device by the communication unit 310. In response to a request from an image processing apparatus 200, the controller 330 sends a processing request and checking information stored in the storage 320 to this image processing apparatus 200.

### (Functional Configuration of Terminal Apparatus)

The functional configuration of the terminal apparatus 100 according to the third exemplary embodiment is similar to that of the first exemplary embodiment. In the third exemplary embodiment, checking information may be feature information concerning the features of the operator of the terminal apparatus 100, as discussed in the first exemplary embodiment, or may be identification information concerning the terminal apparatus 100, as discussed in the second exemplary embodiment. In the third exemplary embodiment, the communication controller 180 sends a processing request and checking information to the server 300.

### (Functional Configuration of Image Processing Apparatus)

The functional configuration of the image processing apparatus 200 according to the third exemplary embodiment is similar to that of the first exemplary embodiment. In the third exemplary embodiment, as the checking information obtaining unit 220, a device, such as a camera or a sensor, discussed in the first exemplary embodiment, or a communication interface discussed in the second exemplary embodiment is used according to the type of information used as checking information.

When the checking information obtaining unit 220 has obtained checking information, the controller 270 queries the server 300 by using this checking information as a key, and obtains a processing request and checking information from the server 300. Upon receiving a processing request and checking information from the server 300, the controller 270 instructs the checking unit 230 to perform checking operation by using the obtained checking information.

### (Checking Operation Using Checking Information)

The operation executed by the terminal apparatus 100 in the third exemplary embodiment is similar to that discussed in the first and second exemplary embodiments with reference to FIG. 4, except that a processing request and checking information are sent to the server 300 instead of to the image processing apparatus 200. The server 300 stores processing requests and checking information obtained from the terminal apparatus 100.

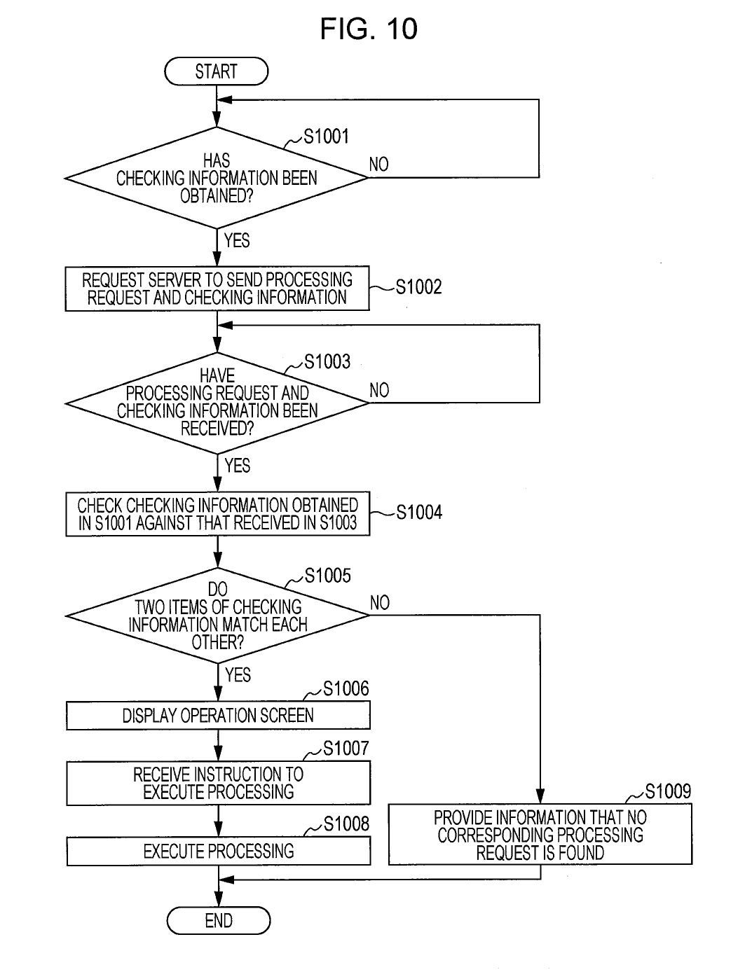

FIG. 10 is a flowchart illustrating a checking operation executed by the image processing apparatus 200. Upon obtaining checking information by using the checking information obtaining unit 220 in step S1001, the image processing apparatus 200 requests the server 300 by using the obtained checking information as a key to send a processing request and checking information in step S1002. If the server 300 stores the corresponding processing request and checking information, it sends them to the image processing apparatus 200.

Then, upon receiving a processing request and checking information from the server 300 (YES in step S1003), the controller 270 of the image processing apparatus 200 causes the checking unit 230 to check the checking information obtained in step S1001 against the checking information received in step S1003. If the two items of checking information match each other (YES in step S1005), in step S1006, the controller 270 causes the display 240 to display an operation screen for executing processing based on the processing request received in step S1003. The operator then operates the operation unit 250 based on the operation screen to provide an instruction to execute processing. The controller 270 receives the instruction in step S1007 and causes the processing executor 260 to execute processing based on the processing request in step S1008. If it is found that the checking information obtained in step S1001 and the checking information received in step S1003 do not match each other (NO in step S1005), in step S1009, the controller 270 provides information that no processing request associated with the checking information is found and terminates processing.

In the above-described operation example, the image processing apparatus 200 queries the server 300 by using the obtained checking information as a key, and causes the checking unit 230 to perform checking operation by using checking information received from the server 300. However, instead of the image processing apparatus 200, the server 300 may perform checking operation. In this case, a checking function of conducting checking by using checking information is provided in the server 300. Upon receiving checking information from the image processing apparatus 200, the server 300 performs checking operation by comparing the received checking information with that stored in the storage 320.

It is now assumed that data to be processed is sent together with a processing request and checking information from the terminal apparatus 100 to the server 300 in the third exemplary embodiment. In this case, the data is stored in the storage 320 of the server 300 and is then sent to the image processing apparatus 200 when the image processing apparatus 200 executes processing. When the image processing apparatus 200 receives an instruction to execute processing from the operator, the operator may change settings for the processing. For example, while data sent from the terminal apparatus 100 to the server 300 is a color image, an instruction to output a monochromatic image may be provided to the image processing apparatus 200. The operator may change settings for the size or the resolution of an output image. If a document file is constituted by plural pages, an instruction to output only some of the plural pages may be provided. In the above-described cases, only part of data stored in the server 300 is required for executing processing depending on the settings. If only part of data is sent from the server 300 to the image processing apparatus 200, a communication load may be lessened.

### Fourth Exemplary Embodiment

### (System Configuration)

The system configuration of a fourth exemplary embodiment is similar to that of the third exemplary embodiment shown in FIG. 8. In the third exemplary embodiment, the server 300 receives a processing request and checking information from the terminal apparatus 100 and sends them to the image processing apparats 200 in response to a request from the image processing apparatus 200 (pull technology). In the fourth exemplary embodiment, upon receiving a processing request and checking information from the terminal apparatus 100, the server 300 selects an image processing apparatus 200 as a sending destination and sends the received processing request and checking information to the selected image processing apparatus 200 (push technology).

### (Functional Configuration of Terminal Apparatus)

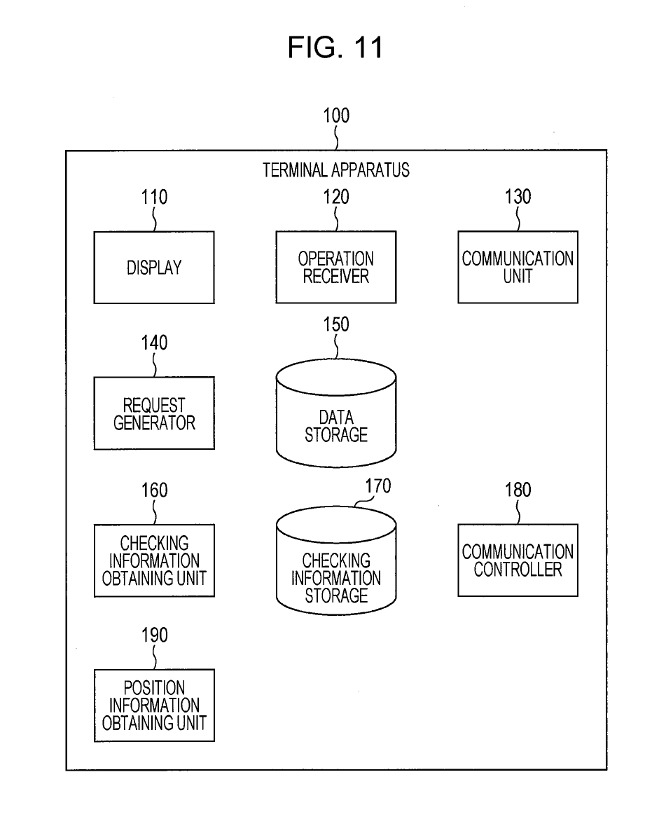

FIG. 11 is a block diagram illustrating an example of the functional configuration of a terminal apparatus 100 according to the fourth exemplary embodiment. The functional configuration of the terminal apparatus 100 according to the fourth exemplary embodiment is similar to that of the first exemplary embodiment. The terminal apparatus 100 shown in FIG. 11 includes a display 110, an operation receiver 120, a communication unit 130, a request generator 140, a data storage 150, a checking information obtaining unit 160, a checking information storage 170, a communication controller 180, and a position information obtaining unit 190. The terminal apparatus 100 shown in FIG. 11 includes the position information obtaining unit 190, unlike the terminal apparatus 100 shown in FIG. 2.

The position information obtaining unit 190 obtains position information for identifying the position of the terminal apparatus 100. If the terminal apparatus 100 is a smartphone or a tablet information terminal, a global positioning system (GPS) function provided in the terminal apparatus 100 may be used as the position information obtaining unit 190.

Upon issuing a processing request and checking information, the communication controller 180 causes the position information obtaining unit 190 to obtain position information indicating the current position of the terminal apparatus 100. The communication controller 180 then sends the position information together with the processing request and checking information to the server 300.

### (Functional Configuration of Server)

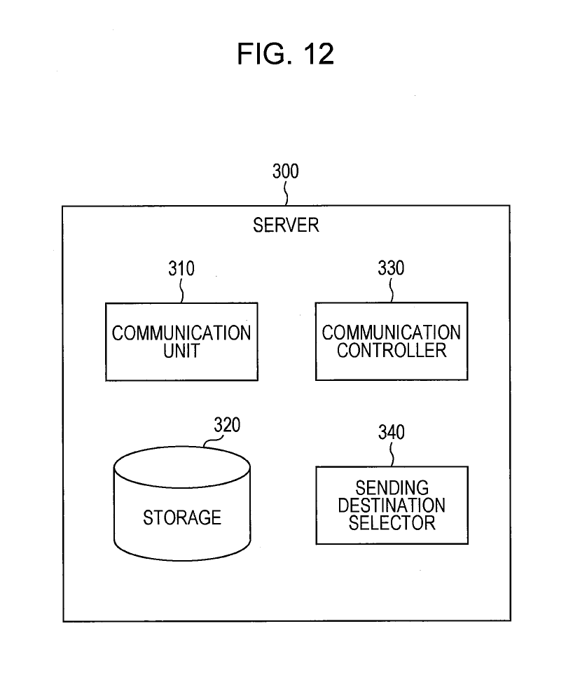

FIG. 12 is a block diagram illustrating an example of the functional configuration of the server 300 according to the fourth exemplary embodiment. The server 300 shown in FIG. 12 includes a communication unit 310, a storage 320, a communication controller 330, and a sending destination selector 340. The communication unit 310 and the storage 320 are similar to the counterparts of the third exemplary embodiment discussed with reference to FIG. 9. Upon receiving a processing request and checking information from the terminal apparatus 100, the communication controller 330 sends the received processing request and checking information to the image processing apparatus 200 selected by the sending destination selector 340.

The sending destination selector 340 searches for an image processing apparatus 200 located within a certain distance from the terminal apparatus 100, based on position information received from the terminal apparatus 100 together with a processing request and checking information. If an image processing apparatus 200 is found within the certain distance, the sending destination selector 340 informs the communication controller 330 of the presence of the detected image processing apparatus 200 as a sending destination. The communication controller 330 then sends the processing request and checking information to the image processing apparatus 200 selected as the sending destination. The communication controller 330 then informs the terminal apparatus 100 that the processing request and checking information have been sent to the image processing apparatus 200. The terminal apparatus 100 displays information concerning the image processing apparatus 200 obtained from the server 300 on the display 110 to present it to the operator.

If no image processing apparatus 200 is found within the certain distance from the terminal apparatus 100, the sending destination selector 340 informs the communication controller 330 of the absence of an image processing apparatus 200. The communication controller 330 then informs the terminal apparatus 100 that no image processing apparatus 200 as a sending destination has been found. In this case, the terminal apparatus 100 may output a message, for example, indicating that no image processing apparatus 200 as a sending destination has been found to the operator.

### (Functional Configuration of Image Processing Apparatus)

The functional configuration of the image processing apparatus 200 according to the fourth exemplary embodiment is similar to that of the first exemplary embodiment. In the fourth exemplary embodiment, as the checking information obtaining unit 220, a device, such as a camera or a sensor, discussed in the first exemplary embodiment, or a communication interface discussed in the second exemplary embodiment is used according to the type of information used as checking information.

### (Checking Operation Using Checking Information)

In the fourth exemplary embodiment, checking operation using checking information is performed in a procedure similar to that of the first exemplary embodiment as discussed with reference to FIGS. 4 and 5. However, in the fourth exemplary embodiment, the terminal apparatus 100 sends a processing request and checking information to the server 300. The image processing apparatus 200 receives a processing request and checking information from the server 300.

### MODIFIED EXAMPLES

The present disclosure has been described through illustration of first through fourth exemplary embodiments. However, the technical scope of the disclosure is not restricted to the above-described exemplary embodiments. Various modifications and alterations may be made and alternative configurations may be employed without departing from the spirit and scope of the disclosure, and such modifications, alterations, and alternatives are encompassed within the disclosure. For example, the operator of the image processing apparatus 200 may not necessarily be the same as that of the terminal apparatus 100, provided that it is possible to identify the operator of the image processing apparatus 200. Unlike the first exemplary embodiment, feature information concerning the features of a person different from the operator of the terminal apparatus 100 may be used as checking information, and checking operation may be conducted by using this feature information. When the checking operation has succeeded, an instruction to execute processing may be provided to the image processing apparatus 200.

In the above-described exemplary embodiments, the image processing apparatus 200 is used as an information processing apparatus that executes processing based on a processing request issued by the terminal apparatus 100. However, the disclosure may be applicable to an information processing system including an information processing apparatus other than the image processing apparatus 200.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system comprising:
a first obtaining unit that obtains first information, the first information being information used for uniquely identifying a user sending a request to execute processing or an apparatus used for sending the request, the first information being issued together with the request and being associated with the request;
a second obtaining unit that obtains, when an instruction to execute the processing is provided, second information to be checked against the first information, the second information being obtained, separately from the first information obtained by the first obtaining unit, from a user providing the instruction or from an apparatus carried by the user;
a third obtaining unit that obtains the request; and
an executor that executes processing based on the request obtained by the third obtaining unit in accordance with a result of checking the second information against the first information.

2. The information processing system according to claim 1, wherein the first information and the second information are obtained from a subject which possesses the second information.

3. The information processing system according to claim 2, wherein the first information and the second information are identification information concerning an apparatus which has issued the request.

4. The information processing system according to claim 2, wherein the first information and the second information are feature information concerning features for identifying an operator of an apparatus which has issued the request.

5. The information processing system according to claim 3, wherein the first information and the second information are feature information concerning features for identifying an operator of an apparatus which has issued the request.

6. The information processing system according to claim 4, wherein the first information and the second information are biometric information concerning an operator of an apparatus which has issued the request.

7. The information processing system according to claim 5, wherein the first information and the second information are biometric information concerning an operator of an apparatus which has issued the request.

8. The information processing system according to claim 1, wherein:
the first obtaining unit obtains the first information and the third obtaining unit obtains the request via a first communication medium; and
the second obtaining unit obtains the second information via a second communication medium, the second communication medium being different from the first communication medium.

9. The information processing system according to claim 8, wherein:
the first obtaining unit obtains the first information and the third obtaining unit obtains the request via the Internet; and
the second obtaining unit obtains the second information via near field communication.

10. The information processing system according to claim 1, further comprising:
a presenter that presents a plurality of processing operations based on a plurality of requests; and
an instruction receiver that receives an instruction to execute at least one of the processing operations presented by the presenter, the instruction being provided by selecting the at least one of the processing operations,
wherein, after the first information and the second information have been checked against each other, the executor executes processing based on the request in accordance with the instruction received by the instruction receiver.

11. The information processing system according to claim 1, further comprising:
an instruction receiver that receives an instruction to execute processing based on the request; and
a fourth obtaining unit that obtains data provided together with the request,
wherein the executor executes processing by using the entirety or part of the data obtained by the fourth obtaining unit in accordance with the instruction received by the instruction receiver.

12. An information processing apparatus comprising:
an operation receiver that receives an operation performed by an operator;
a first obtaining unit that obtains first information, the first information being issued together with a request to execute processing and being associated with the request;
a second obtaining unit that obtains second information provided by the operator;
a third obtaining unit that obtains the request; and
an executor that executes processing based on the request in response to an instruction to execute the processing received by the operation receiver, in accordance with a result of checking the second information against the first information.

13. An information processing system comprising:
first obtaining means for obtaining first information, the first information being information used for uniquely identifying a user sending a request to execute processing or an apparatus used for sending the request, the first information being issued together with the request and being associated with the request;
second obtaining means for obtaining, when an instruction to execute the processing is provided, second information to be checked against the first information, the second information being obtained, separately from the first information obtained by the first obtaining means, from a user providing the instruction or from an apparatus carried by the user;
third obtaining means for obtaining the request; and
executing means for executing processing based on the request obtained by the third obtaining means in accordance with a result of checking the second information against the first information.
